(19) United States
(12) Patent Application Publication
(10) Pub. No.: US 2025/0200618 A1
(43) Pub. Date: Jun. 19, 2025

(54) GRAPH NETWORK EMBEDDING GENERATION

(71) Applicant: CoreLogic Solutions, LLC, Irvine, CA (US)

(72) Inventors: Kien Trong Trinh, San Diego, CA (US); Wei Geng, San Diego, CA (US); Bin He, Philadelphia, PA (US)

(21) Appl. No.: 18/984,620

(22) Filed: Dec. 17, 2024

Related U.S. Application Data
(60) Provisional application No. 63/612,265, filed on Dec. 19, 2023.

(51) Int. Cl. G06Q 30/02

(52) U.S. Cl. CPC G06Q 30/0278

(57) ABSTRACT

A device may receive first information associated with one or more properties, and second information associated with one or more properties, where the first information is of a different information type than the second information. The device may generate a first graph network based on the first information, and a second graph network based on the second information. The device may combine the first graph network and the second graph network to generate a combined network including a portion of the first information and a portion of the second information. The device may generate an embedding based on the combined graph network. The device may apply the feature embedding as input to a housing model to generate an output.

### CROSS-REFERENCE TO RELATED APPLICATIONS

This application claims priority under 35 U.S.C. § 119 (e) to U.S. Provisional Application No. 63/612,265, filed Dec. 19, 2023, and titled “GRAPH NETWORK EMBEDDING GENERATION,” which is hereby incorporated by reference herein in its entirety.

### BACKGROUND

Information, such as appraisal values or property geometries, for a set of properties may be organized into a graph network structure. Embeddings may be generated from the graph network structure for use by a machine learning model. The machine learning model may use the embeddings generated from the graph network structure to provide further insight into one or more properties of the set of properties, or into the set of properties as a whole.

### SUMMARY

In some aspects, the techniques described herein relate to a system including: a computer-readable memory that store computer-executable instructions; and one or more processors in communication with the memory, where the computer-executable instructions, when executed by the one or more processors, causes the one or more processors to at least: receive a first information item; generate a first graph network based on the first information item, the first graph network including a first plurality of nodes, where each node of the first plurality of nodes is associated with a property, the first graph network further including a first plurality of edges, where each edge of the first plurality of edges couples two nodes of the first graph network, and where each edge of the first plurality of edges represents a connection between the properties represented by the first plurality of nodes; receive a second information item; generate a second graph network based on the second information item, where the second graph network includes a second plurality of edges and a second plurality of nodes; determine a first node of the first graph network represents a property, where the first node is associated with a first node data object; determine a second node of the second graph network represents the property, where the second node is associated with a second node data object; combine the first node data object with the second node data object to generate a combined node data object, where the combined node data object includes a portion of a combined graph network formed from a combination of the first graph network and the second graph network; and output the combined graph network.

The system of the preceding paragraph can include any sub-combination of the following features: where the first information item is one of an appraisal value, geometric property information, address information, socioeconomic information, or census data; where the second information item is one of: an appraisal value, geometric property information, address information, socioeconomic information, or census data; and where the second information item is different from the first information item, where the computer-executable instructions, when executed, further cause the one or more processors to generate a first plurality of weight values, where each weight value of the first plurality of weight values is associated with an edge of the first plurality of edges, and where each weight value indicates a strength of coupling between two nodes coupled by the edge associated with the weight value; and generate a second plurality of weight values, where each weight value of the second plurality of weight values is associated with an edge of the second plurality of edges; where the computer-executable instructions, when executed, further cause the one or more processors to: determine a first edge of the first plurality of edges couples a first node to a second node, where the first edge is associated with a first weight; determine a second edge of the second plurality of edges couples the first node to the second node, where the second edge is associated with a second weight; receive a hierarchy of graph network data types; identify a first graph network data type of the first graph network; identify a second graph network data type of the second graph network; determine the first graph network data type represents a graph network data type above the second graph network data type in the hierarchy; combine the first edge with the second edge to generate a combined edge, where the combined edge couples the first node and the second node; and in response to determining the first graph network data type represents the graph network data type at a level indicating a higher priority than the second graph network data type in the hierarchy associate the first weight with the combined edge; where the first graph network data type is an appraisal value, and where the second graph network data type is different from the first graph network data type; determine a first edge of the first plurality of edges couples a first node to a second node, where the first edge is associated with a first weight; determine a second edge of the second plurality of edges couples the first node to the second node, where the second edge is associated with a second weight; combine the first edge with the second edge to generate a combined edge, where the combined edge couples the first node to the second node; generate an average weight value of the first weight and the second weight; and associate the average value with the combined edge.

Another aspect of the disclosure provides a method including: receiving a first information item; generating a first graph network based on the first information item, the first graph network including a first plurality of nodes, where each node of the first plurality of nodes is associated with a property, the first graph network further including a first plurality of edges, where each edge of the first plurality of edges couples two nodes of the first graph network, and where each edge of the first plurality of edges represents a connection between the properties represented by the first plurality of nodes; receiving a second information item; generating a second graph network based on the second information item, where the second graph network includes a second plurality of edges and a second plurality of nodes; combining the first graph network and the second graph network to generate a combined graph network, where combining the first graph network and the second graph network further includes: determining a first node of the first graph network represents a property, where the first node is associated with a first node data object; determining a second node of the second graph network represents the property, where the second node is associated with a second node data object; and combining the first node data object with the second node data object to generate a combined node data object; and outputting the combined graph network.

The method of the preceding paragraph can include any sub-combination of the following features: where combining the first graph network and the second graph network to generate the combined graph network further includes: determining a first edge of the first plurality of edges couples a first node to a second node, where the first edge is associated with a first edge data object; determining a second edge of the second plurality of edges couples the first node to the second node, where the second edge is associated with a second edge data object; and combining the first node edge object with the second edge data object to generate a combined edge data object; where each edge of the first plurality of edges is associated with an edge data object of a first plurality of edge data objects, where each edge of the second plurality of edges is associated with an edge data object of a second plurality of data objects; generating a first plurality of weight values, where each weight value of the first plurality of weight values is associated with an edge of the first plurality of edges, where each weight value indicates a strength of coupling between two nodes coupled by an edge associated with the weight value, and where each weight value of the first plurality of weight values is stored in an edge data object of the first plurality of edge data objects; and generating a second plurality of weight values, where each weight value of the second plurality of weight values is associated with an edge of the second plurality of edges, and where each weight value of the second plurality of weight values is stored in an edge data object of the second plurality of edge data objects; determining a weight value of the first plurality of weight values fails to reach a threshold value, and removing an edge of the plurality of edges associated with the weight value from the plurality of edges; determining a weight value of the first plurality of weight values exceeds a threshold value, and assigning the weight value of the first plurality of weight values a value of one; generating a graph network embedding for the combined graph network, using a machine learning model configured to generate an embedding based on receiving a graph network as input; providing the graph network embedding as input to a housing model configured to accept an embedding as input and generate a housing information item; and receiving the housing information item; where the first information item is of a first information type, where the second information item is of a second information type, and where the first information type is different from the second information type.

In some aspects, the techniques described herein relate to a non-transitory, computer-readable medium encoded with computer-executable instructions executable by a processor of a computing device, where the computer-executable instructions, when executed by the processor, cause the computing device to: receive a first information item; generate a first graph network based on the first information item, the first graph network including a first plurality of nodes, where each node of the first plurality of nodes is associated with a property, the first graph network further including a first plurality of edges, where each edge of the first plurality of edges couples two nodes of the first graph network, and where each edge of the first plurality of edges represents a connection between the properties represented by the first plurality of nodes; receive a second information item; generate a second graph network based on the second information item, where the second graph network includes a second plurality of edges and a second plurality of nodes; determine a first node of the first graph network represents a property, where the first node is associated with a first node data object; determine a second node of the second graph network represents the property, where the second node is associated with a second node data object; combine the first node data object with the second node data object to generate a combined node data object, where the combined node data object is associated with a combined node, and where the combined node represents the property, and where the combined node data object includes a portion of a combined graph network formed from a combination of the first graph network and the second graph network; and output the combined graph network.

The computer-implemented method of the preceding paragraph may include any sub-combination of the following features: determine the combined node data object includes a data element that fails to exceed a threshold value; and in response to determining the combined node data object includes a data element that fails to exceed the threshold value, remove the combined node from the combined graph network; where the first information item is of a first information type, where the second information item is of a second information type, and where the first information type is different from the second information type; determine a property of a plurality of properties associated with each node of the first plurality of nodes; determine the property of the plurality of properties associated with each node of the second plurality of nodes; and combine a first node data object of the first plurality of node data objects associated with each property and a second node data object of the second plurality of node data objects associated with each property to generate a combined plurality of node data objects, where the combined graph network further includes the combined plurality of node data objects; determine a third node of the first plurality of nodes is associated with a second property; and determine the second property is not associated with any node of the second plurality of nodes, where the combined graph network further includes a third node data object associated with the third node.

### BRIEF DESCRIPTION OF THE DRAWINGS

Embodiments of various inventive features will now be described with reference to the following drawings. Throughout the drawings, reference numbers may be re-used to indicate correspondence between referenced elements. The drawings are provided to illustrate example embodiments described herein and are not intended to limit the scope of the disclosure. To easily identify the discussion of any particular element or act, the most significant digit(s) in a reference number typically refers to the figure number in which that element is first introduced.

FIG. 1 is a block diagram of illustrative data flows within a property graph and embedding generation system according to some embodiments.

FIG. 2 is a flow diagram of an illustrative routine for generating a property graph and generating embeddings from the property graph to be processed for the generation of additional information according to some embodiments.

FIG. 3 is a flow diagram of an illustrative routine for generating embeddings from a property graph according to some embodiments.

FIG. 4A is an illustrative example of a property graph indicating geometric information by graph edges according to some embodiments.

FIG. 4B is an illustrative example of a property graph indicating appraisal information by graph edges according to some embodiments.

FIG. 4C is an illustrative example of a property graph combining a plurality of information types to generate graph edges according to some embodiments.

FIG. 5 is a block diagram of an illustrative computing system configured to provide generation of a graph network and associated embeddings according to some embodiments.

### DETAILED DESCRIPTION

The present disclosure relates to the generation of a combined graph network structure comprising information from a plurality of sub-graph network structures, and generating embeddings from such graph network structures. Specifically, the sub-graph networks may each represent one or more information types (e.g., assessed property values, geometric property information, housing information, ZIP code information, census information, socioeconomic information, street address information, etc.), where the information types represented by each sub-graph are less than all information types available. The sub-graph networks may then be combined into a graph network comprising information from each sub-graph.

Some conventional systems allow for converting housing information into a graph network structure. Such systems may receive a type of housing information, and apply a method to convert the housing information into a graph network made up of nodes representing properties or locations, and edges connecting nodes to each other based on the information indicating associations between the properties represented by the nodes. Additionally, systems and algorithms exist to generate embeddings for use in machine learning models from graph networks. Embeddings generated by such systems may be limited in the amount of information they contain, due to the graph network from which the embeddings are generated being limited in the amount and/or type of data stored therein. These limitations on the information contained in the generated embeddings may affect the ability of a machine learning model accepting the embedding as input to generate correct or useful outputs. Further, when embeddings are generated from multiple sub-graph networks, the machine learning models may require configuration to accept multiple embeddings as input in order to process information from each sub-graph for a final output. Such an arrangement may require a larger machine learning model configured to accept multiple embeddings substantially simultaneously, additional computational resources, or additional time as the machine learning model may need to be configured to generate an output suitable to be provided to the same machine learning model as input along with an additional embedding.

Some aspects of the present disclosure address some or all of the issues noted above, among others, by providing for the combination of multiple graph networks into a single, combined graph network containing information from each of the sub-graph networks on which it is based. Embeddings may then be generated from the combined graph network, and such embeddings may contain information from each sub-graph used to generate the combined graph network.

In some embodiments, a graph network generation system receives information from a first data source, such as housing or neighborhood information, and generates a sub-graph network representing the received information. Alternatively, the graph network generation system may receive the information from a plurality of data sources. For example, the information may be property geometry information for properties zoned as residential within a 0.5 mile radius centered around a point (e.g., a point centered around a property). The property geometry information may be stored in a plurality of information sources, for example when the 0.5 mile radius encompasses property within two counties each maintaining separate land use records. The size of this radius is exemplary only, and other values may be used. Further, the size of the radius may vary based on a density of properties of interest within an area, for example the radius may be expanded to 5 miles in rural areas, and restricted to 0.5 miles in denser urban areas.

The graph network generation system may then use the property geometry information to generate a first sub-graph. In this example, the nodes of the first sub-graph may represent all properties zoned as residential within the 10 mile area of interest. The nodes of the sub-graph may have associated node data structures which include information associated with the property represented by the node (e.g., lot size, housing square footage, number of bedrooms, ZIP code, socioeconomic data, etc.). Further, edges may connect nodes of the sub-graph based on information indicating an association between the properties represented by the nodes. As with the nodes, edges of the sub-graph may have associated edge data structures which include information associated with the connection between two nodes (e.g., length of a shared property boundary). For property geometry information, an edge may indicate a shared boundary between two properties.

Additionally, the edges of the sub-graph may be assigned weight values by the graph network generation system. Weight values may indicate a strength of the association between two nodes. When referring to property geometry information in this example, a weight may indicate the length of the shared boundary between two properties. Weight values for the edges may be normalized, such that all weight values fall between 0 and 1. In some embodiments, edges with a weight value of 0, or a weight value outside of a threshold, may be removed from the graph network, which may improve the computational efficiency of creating embeddings from the resulting sub-graph by reducing the information which needs to be processed when generating embeddings when such removed information (e.g., removed edges) are unlikely to significantly contribute to further processing of the embedding.

For example, properties within the same census block or subdivision can be interconnected to create sub-graphs. The weights of the edges are determined by the differences in their characteristics, including property type, total square footage, number of bedrooms, and so on. Subsequently, a threshold is established to eliminate connections between properties, thus refining the graph. A better graph is characterized by connections between similar nodes, while dissimilar nodes should not be connected. Alternatively, edges may be provided default weight values. Default weight values may be 0 or 1. In some embodiments, various thresholds may be used to assign weight values to an associated edge between 0 and 1 (e.g., a shared boundary of 1 meter may result in a weight value of 0, shared boundaries between 1 meter and 50 meters may result in a weight value of 0.5, and shared boundaries exceeding 50 meters may result in a weight value for the associated edge of 1). In some embodiments, nodes connected only to edges having a weight value of 0 may also be removed from the sub-graph, which may reduce storage requirements and improve the quality of the embedding generated from the sub-graph information.

The graph network system may generate a plurality of sub-graphs, each based on a subset of information available to the graph network system in the manner described previously herein. The graph network system may then combine the plurality of sub-graphs into a combined graph network. Combining the sub-graphs into a combined graph may begin by identifying nodes shared between two or more sub-graphs. Nodes shared between two or more sub-graphs may have node data structures associated with the node in some or all of the sub-graphs combined, such that a combined node data structure is created which includes information from the node data structure for the shared node from multiple sub-graphs. The same process may be performed for edges of the sub-graphs, where edges that exist in multiple sub-graphs have their information combined into a combined edge data structure. Additionally, a node or edge may exist in only one sub-graph, but may connect to a node or edge in the combined graph. The graph network generation system may then include such nodes and edges in the combined graph. Further, the node data structure and/or the edge data structure may include information indicating from what sub-graph the node or edge originates, or indicate if the node or edge originates from multiple sub-graphs. The combined graph network may include substantially all of the nodes and edges at this stage.

Weight values may then be applied to edges of the combined graph. The weight values may be based on weight values for the edges in the sub-graph from which the edge originates. When an edge exists in multiple sub-graphs, a combined weight value may be assigned to the edge in the combined graph. The combined weight value may be calculated based on the weight value for the edge in each sub-graph in which the edge exists. In some embodiments, a hierarchy of sub-graphs may be provided or determined. The hierarchy of sub-graphs may indicate the relevance to further processing of the sub-graph from which it originates. For example, if a first sub-graph is generated based on property geometry information, and a second sub-graph is generated based on appraisal value, it may be determined that appraisal value is more relevant (e.g., provides for more accurate results) to machine learning models performing additional processing on embeddings generated from graph networks. In such an example, where an edge exists in both the first sub-graph and the second sub-graph, the combined edge weight for the edge may be assigned to the weight given to the edge in the second sub-graph (e.g., the more relevant subgraph). Alternatively, a calculated combined weight may be determined for the edge, and the weight from the second sub-graph may have a larger effect on the resulting combined weight based on the weight from the second sub-graph being more relevant.

When a combined graph network is generated by the graph network generation system, the combined graph may be provided to an embedding generation system. The embedding generation system may comprise a machine learning model configured to generate embedding information from graph network information. Alternatively, the embedding generation system may apply one or more algorithms designed to generate embedding information from graph information. The generated embeddings may represent information associated with some or all of the nodes of the graph network. Such embeddings would provide information for the property associated with the node, and may further include information from edges connected to the node and/or other nodes connected by edges to the node. Embeddings generated by the embedding generation system may then be provided to machine learning models (e.g., housing models) as input for further processing.

Certain aspects and implementations are discussed herein with reference to use of a machine learning (ML) model, those aspects and implementations may be performed by any other artificial intelligence (AI) model, generative AI model, generative model, neural network (NN), deep-learning NN, multimodal model, and/or other algorithmic processes. Examples of models, that may be used in various implementations of the present disclosure include, for example, feed-forward NNs, NNs having one or more fully connected layers, graph neural networks (GNNs), Bidirectional Encoder Representations from Transformers (BERT), and the like.

Various aspects of the disclosure will be described with regard to certain examples and embodiments, which are intended to illustrate but not limit the disclosure. Although aspects of some embodiments described in the disclosure will focus, for the purpose of illustration, on particular examples of machine learning models, information modalities, and the like, the examples are illustrative only and are not intended to be limiting. In some embodiments, the techniques described herein may be applied to additional or alternative types of machine learning models, information modalities, and the like. Additionally, any feature used in any embodiment described herein may be used in any combination with any other feature or in any other embodiment, without limitation.

### Example Property Graph and Embedding Generation System

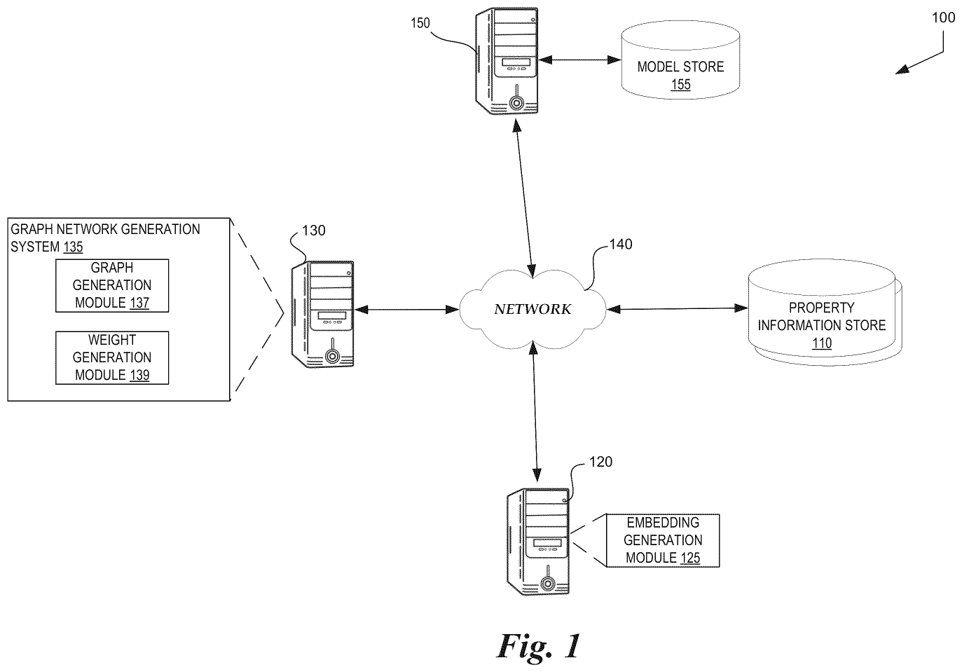

With reference to an illustrative example, FIG. 1 shows an illustrative system 100. The system 100 comprises a graph network generation system 130, an embedding generation system 120, a property information store 110, a model application system 150, and a network 140. While the components of this example illustrative system 100 are discussed here individually, it should be understood that some or all of these components may operate on the same device.

The property information store 110 comprises one or more data storage locations containing multi-modal information associated with at least one property. Examples of information stored by the housing information store 110 include, but are not limited to, Multiple Listing Service (MLS) text including public remarks associated with a property, neighborhood information (e.g., neighborhood information formatted as a neighborhood network in a graph structure), MLS property photographs, virtual property tour information (e.g., 360° photographs, video information, audio information, etc.), privately owned property data, geographic information associated with a property, geometric information associated with a property, appraisal values for one or more properties, and/or publicly accessible property data (e.g., public sales information, public listing date, street address information, etc.).

The network 140 may be any combination of a local area network (“LAN”) and/or a wireless area network (“WAN”) or the like. In some embodiments, the various components of the system 100 may, in various implementations, communicate with one another directly or indirectly via any appropriate communications links (e.g., one or more communications links, one or more computer networks, one or more wired or wireless connections, the Internet, any combination of the foregoing, and/or the like).

The embedding generation system 120 comprises an embedding generation module 125. The embedding generation system 120 is a system configured to receive property information in the form of a graph network from the graph network generation system 130 and generate, by the embedding generation module 125, embeddings comprising feature information associated with properties represented as nodes in the graph network.

The embedding generation module 125 is configured to receive information representing a graph network. A graph network may include nodes and edges, where each node represents a property. Edges of the graph network may represent information connecting properties represented as nodes. For example, an edge connecting two nodes in a graph network representing appraisal information may indicate that the properties represented by the nodes are similar. Further, edges may be weighted to indicate a strength of the connection between two nodes. The strength of the connection between nodes represented by a weight value for the associated edge may indicate a similarity between properties represented by the nodes. The embedding generation module 125 generates as output embeddings including information for the property associated with a node of the graph network, based in part on information associated with the node and/or an edge connected to the node. The embedding generation module 125 may comprise one or more machine learning models trained to generate embeddings from a graph network. The embedding generation module 125 may use an algorithm to generate embeddings from a graph network, for example the node2vec algorithm.

The graph network generation system 130 is configured to receive information (e.g., appraisal information, census information, socioeconomic information, ZIP code information, geometric information, street address information, etc.), and generate a graph network representation of the information. Additionally, the graph network generation system 130 may be configured to generate a plurality of sub-graph network. Each sub-graph network may represent information for less than all available information sources (e.g., one information source stored in property information store 110). The graph network generation system 130 may further be configured to combine two or more sub-graph networks (e.g., graph networks based on less than all available information) into a combined graph network based on information contained in each of the sub-graph networks.

The graph network generation system 130 comprises a graph network generation system 135. The graph network generation system 135 includes a graph generation module 137, and a weight generation module 139.

The graph generation module 137 of this example embodiment is configured to generate graph network information for a sub-graph or graph network. Generating a sub-graph network may follow the same process as generating a graph network, where the difference between a sub-graph network and a graph network may be the amount or type of information used to generate the network. In order to improve clarity of this description, the terms sub-graph network and graph network will be used interchangeably when describing the generation of graph networks by the graph generation module 137 and the weight generation module 139.

Graph network information may include node information and edge information. For example, nodes of a graph network may each represent a property. The graph generation module 137 may associate a node data structure with a node. The data structure may include property information, for example, geographic information, neighborhood information, socioeconomic information, ownership information, property value information, a date of last assessment, a number of bedrooms of the property, or any other information associated with a property represented by the node. The nodes of the graph network may be connected by edges. The graph generation module 137 may further associate an edge data structure with an edge. The edge data structure may include information associated with a relationship between the nodes connected by the edge. For example, edge information may indicate a reason an edge connects two nodes, such as a shared number of bedrooms, a shared geographic boundary, a shared neighborhood, a shared subdivision, a similar appraisal value (e.g., the appraised value of each node is within a threshold range), a shared land use designation, an age of a property associated with each connected node, or any other information indicating a connection between two nodes. The graph generation module 137 may then combine node information and edge information for a plurality of nodes and edges to generate graph network information.

The weight generation module 139 of this example embodiment is configured to generate weight values for edges of a graph network. Weight values may, in some cases, indicate a strength of a connection between two nodes represented by an edge. Various methods may be used to generate a weight value for an edge, including the following non-limiting examples. Where an appraisal or sale value is known for two properties, represented as nodes connected by an edge, the weight of the edge may be calculated based on a difference between the appraisal or sale value of the two properties. Where an age is known for two properties, represented as nodes connected by an edge, the weight of the edge may be calculated based on the age of the properties. Where a square footage is known for two properties, represented as nodes connected by an edge, the weight of the edge may be calculated based on the square footage. Where a geographic distance is known for two properties, represented as nodes connected by an edge, the weight of the edge may be calculated based on the geographic distance. Additionally, weights may be used in part to set a threshold value under which an edge will be removed (e.g., pruned) from the graph network. Alternatively, the calculation of a weight value may be designed to set a weight for an edge to zero, or so low as to create substantially zero contribution from the edge, when a difference between information for two properties is outside a threshold value (e.g., when two properties exceed a threshold geographic distance from each other). The information from which weights are calculated in the examples described herein are intended to be exemplary only, and other information associated with properties represented as nodes in the graph network may be used to generate weight values. Additionally, a single weight value may be generated based on two or more types of property information, for example based on an age of two properties and a geographic distance of the two properties. In some embodiments, a graph network generated may be generated by the graph generation module 137 based on a first type of information (e.g., property geometry information), and the weights of the edges of the graph network may be determined based on a second type of information (e.g., appraisal comparison information).

As described previously herein, the graph network generation system 130 may combine multiple sub-graph networks into a combined graph network. Combining sub-graph networks into a combined graph network may involve determining shared nodes (e.g., properties) from the sub-graphs, and identifying duplicate and/or unique edges of each sub-graph. Where duplicate edges (e.g., an edge exists between two nodes in multiple sub-graphs) of two or more subgraphs are identified, the graph network generation system 130 may discard all but one of the duplicate edges to generate the combined edge. Alternatively, the graph network generation system 130 may combine information from multiple edges to create the combined edge, for example by generating a data structure which includes information from two or more of the duplicate edges. Further, where the edges of two or more sub-graphs are weighted the graph network generation system 130 may determine a new weight value for the combined edge. For example, there may be a priority associated with the sub-graph networks, which may be based on an importance of the information used to generate the sub-graph network from which a weight is taken. In some cases, a highest priority weighting may be used as the new weight value for the combined edge. Alternatively, an average weight value may be taken from at least some of the duplicate edges, and the average weight value may be assigned as the weight value for the combined edge. Further, the weighting of the combined edge may be generated by using a priority of each duplicate edge to determine a weighting of each duplicate edge's weight value. For example, a highest priority edge may have its weight multiplied by a first fixed value (e.g., 0.7) to generate a first calculated weight value. The first fixed value may be greater than a second fixed value by which a lower priority edge has its weight multiplied (e.g., 0.3) to generate a second calculated weight value. In some examples, the value by which a weight is multiplied may be dynamic, determined by a function, or otherwise differ between two edges associated with a same information type (e.g., two edges associated with geographic information). The calculated weight values of this example may then be combined by addition, averaging, or any other method to generate a combined edge weight value for the combined edge. The combined edge weight value may be normalized, such that no combined edge weight value exceeds a value of 1.

The model application system 150 is configured to apply one or more machine learning models to an embedding generated by the embedding generation system 120, and comprises a model store 155. The model store 155 is configured to store a plurality of machine learning models configured to accept as input a feature embedding, and generate additional property information from the feature embedding. Additionally, the model store 155 may store machine learning models configured to accept as input a plurality of feature embeddings and generate insights associated with, for example, a housing type (e.g., rental, low-income housing, for sale by owner, etc.), housing feature (e.g., four bedroom with two bathrooms, ranch-style house, semi-detached house, etc.), neighborhood type (e.g., suburban, sparse housing, etc.), and/or neighborhood feature (e.g., highly rated school district, distance from public transportation, zoning type, etc.).

### Example Graph Network Embedding Generation Process

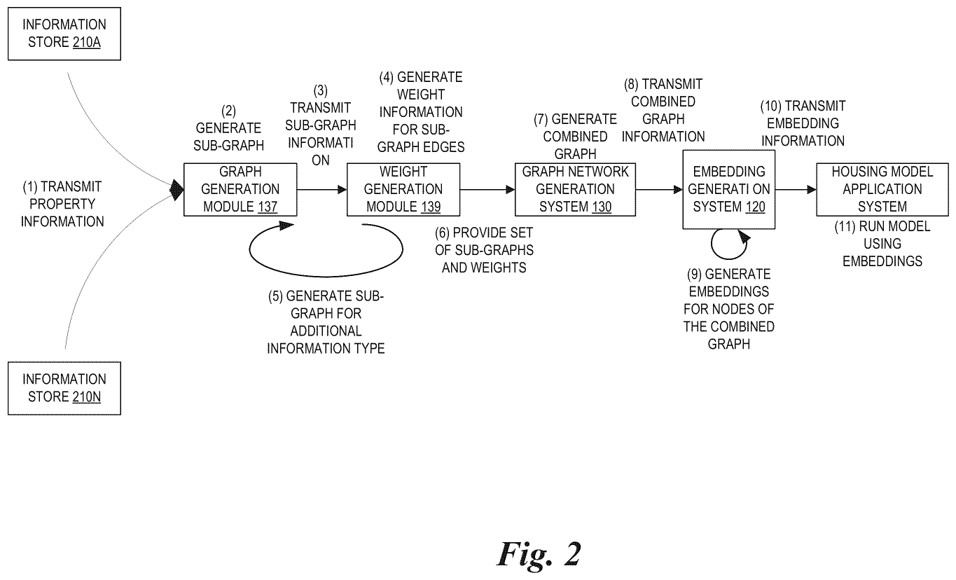

FIG. 2 illustrates an example process 200 for generating a graph network from property information, and generating embeddings based on the graph network. The process 200 starts at (1) where property information is transmitted from a plurality of property information stores 210A-210N (e.g., property information store 110) to the graph generation module 137 of the graph network generation system 130. For example, a first information received from information store 210A may be land use type information. A second information received from 210N in this example may be property square footage information. Any number of additional information stores may transmit information associated with a property, or information useful for providing context in generating a graph network of properties by the graph generation module 137.

At (2), the graph generation module 137 generates a sub-graph from at least one information type received from an information store 210A-210N. As described previously herein, the graph generation module 137 may generate node information associated with properties in the information received from the information store. Further, the graph generation module 137 may generate node data structures containing property information for the property represented by the node. Additionally, the graph generation module 137 generates edges connecting the nodes of the graph network. The edges may indicate relationships between the properties represented by the nodes of the graph network. Additionally, the graph generation module 137 may generate an edge data structure associated with an edge. The edge data structure may contain information associated with the connection between the nodes. Further, the edge data structure may include weight information for the edge. As used herein the term node may include both a node and its associated node data structure, and the term edge may include both an edge and its associated edge data structure. The graph generation module 137 then generates a sub-graph network from the nodes and edges.

At (3) the sub-graph information is transmitted form the graph generation module 137 to the weight generation module 139, so that the weight generation module 139 may generate weight information for the edges. In some embodiments, (3) may be optional, for example where weight information will not be generated for the sub-graph.

At (4), the weight generation module 139 generates weight information for the sub-graph as described in relation to FIG. 1 previously herein. Weight information may be generated for some, or all, of the edges of the sub-graph. The generated weight information for an edge may be stored in an edge data structure associated with the edge. In some embodiments, a default weight (e.g., a weight value of 1) may be assigned to each edge by the weight generation module 139, for example where information to generate weights is not present in the information received from a property information store 110 or other information source. In some embodiments, the default weight may be temporary, and the weight generation module 139 may generate weight information for an edge when the information needed to generate the weight information is received.

At (5), (2)-(4) repeat until a sub-graph has been generated for each information type of interest.

At (6) the set of sub-graphs generated by the graph generation module 137 and the weight generation module 139 of the graph network generation system 135 are provided to the graph network generation system 130.

At (7) the graph network generation system 130 combines the sub-graphs into a combined graph as described previously herein with respect to FIG. 1.

At (8) the combined graph information is transmitted to the embedding generation system 120.

At (9) the embedding generation system 120 generates an embedding for nodes of the combined graph. The embedding generation system 120 may use the node data structure associated with a node to generate the embedding. Additionally, the embedding generation system 120 may use information from some or all of the edges connected to the node and the edge data structures associated with such edges. Further, the embedding generation system 120 may use information about the combined graph network to generate the embedding. For example, the embedding generation system 120 may use the node2vec algorithm to take node information for a node and edge information associated with the node to generate an embedding. Advantageously, representing the nodes of the combined graph network as embeddings using node2vec maps the nodes to a low-dimensional space of features that maximizes the likelihood of preserving network neighborhoods of nodes, while providing an input vector suitable for use in various machine learning models.

### Example Graph Network Embedding Generation Routine

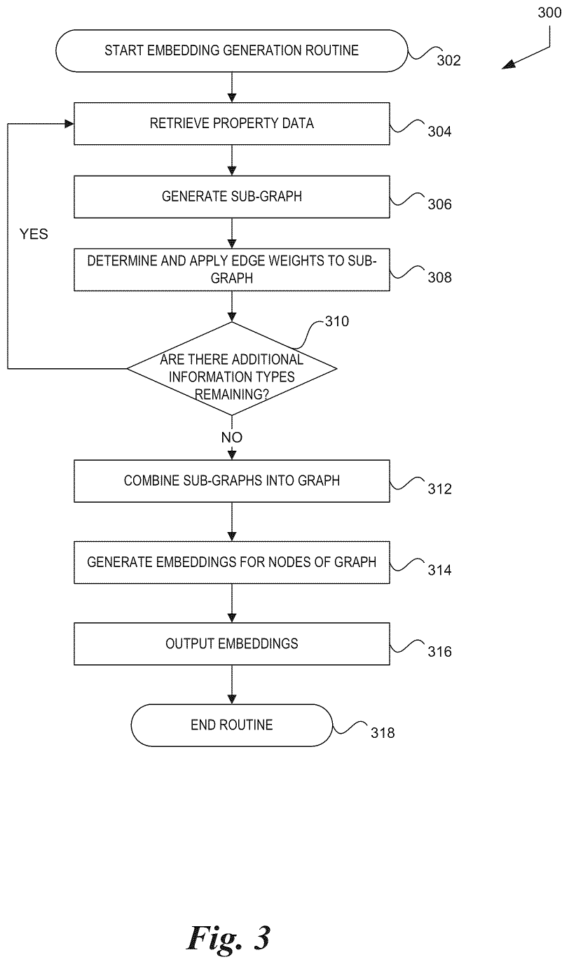

FIG. 3 illustrates example routine 300 for generating a graph network, an embedding representing feature information associated with a node of the graph network, and providing the embedding for further use by a machine learning model (e.g., a housing model of the model store 155). The routine 300 begins at block 302, for example, in response to receiving a request to generate housing information using the model application system 150. The request may further indicate a classification or grouping of properties to be used to create the graph network from which the embeddings will be generated. For example, the request may include an indication of a geographic region, threshold distance from a property, housing type (e.g., three bedroom two bathroom houses), census classification, ZIP code, land use type, etc. Alternatively, the request may indicate a housing model to which the embeddings will be applied and, for example, the graph network generation system 130 may determine a type of information to request from the property information store 110 from which a graph network will be generated to provide embeddings based on an information type associated with the housing model.

At block 304, the graph network generation system 130 retrieves property data from a property information store 110. In some embodiments, property information may not be available in the property information store 110, and the property information store 110 may be updated with additional information available from a public or private data source such that the information necessary to generate a sub-graph network, graph network, or utilize the housing model, is available to the graph network generation system 130. Additionally, retrieved property data may be grouped based at least in part on the indication received in the request (e.g., properties may be determined to be similar and grouped based on census data for the properties). When property information has been received by the graph network generation system 130, the routine 300 moves to block 306.

At block 306, the graph network generation system 135 of the graph network generation system 130 generates a sub-graph network based on information received from a property information store 110. In some embodiments, the sub-graph may be generated based on information received from two or more property information stores 110. The graph generation module 137 may generate a graph network having a plurality of nodes, where the nodes are connected by a plurality of edges. The nodes may represent properties, and the edges may represent associations between the properties. Further, the nodes may be associated with a node data structure storing information for the property associated with the node. The edges may be associated with an edge data structure storing information associated with the edge, or indicating a reasoning for the edge to connect two nodes. When the sub-graph network has been generated, the routine 300 moves to block 308.

At block 308, the weight generation module 139 determines weights to apply to the edges of the sub-graph network generated by the graph generation module 137. The weights may be generated based on the strength of a connection between two nodes as indicated by information associated with each node, for example in the node data structure or the edge data structure. Additionally, the weight value may be used to remove, or prune, edges from the sub-graph network by using a weight calculation which sets an edge weight value to substantially zero when the edge is intended to be ignored or removed (e.g., because the edge represents a connection outside some threshold value, for example the edge represents a connection between properties separated by a geographic distance exceeding a threshold value). In some embodiments, a threshold value may be used for the generated weights, outside which an edge weight will be set to zero to remove the edge's contribution to the sub-graph network. Advantageously, setting an edge weight value to zero may remove extraneous or unnecessary connections between nodes from being used in the generation of an embedding for the attached nodes, thereby improving the usefulness of the generated embedding for each node. In some embodiments, a default weight value may be applied to some or all of the edges of the sub-graph network. The default value may be determined based on a property of the edge stored in the edge data structure associated with the edge. For example, edges connecting nodes associated with properties having a same number of bedrooms may be assigned a weight value of one, and edges connecting nodes associated with properties having a different number of bedrooms may be set to zero. The default weight value may instead be assigned to an edge based on a property of the edge exceeding or falling below a threshold value. The threshold value may be dynamic, and may be adjusted based on information used to generate the sub-graph network, or information determined from an analysis of the sub-graph network. When edge weights have been applied to edges of the sub-graph, the routine 300 moves to block 310.

At decision block 310, a determination is made as to whether information types from which sub-graphs are to be generated remain to be processed. If there are information types remaining from which a sub-graph is to be generated, the routine 300 returns to block 304. If there are no information types remaining from which a sub-graph is to be generated, the routine 300 moves to block 312.

At block 312, the graph network generation system 130 combines the sub-graphs generated by the graph network generation system 135. In some embodiments, only one sub-graph network is to be generated, and the routine 300 proceeds to block 314. As described in relation to FIG. 1 previously herein, combining sub-graphs into a combined graph network may include connecting nodes from different sub-graphs using edge information from one or more sub-graphs. Additionally, nodes associated with properties which exist in two or more sub-graphs may be combined by combining the node data structure associated with the node from each sub-graph. For example, a first property may be represented by a first node in a first sub-graph, and the first property may further be represented by a second node in a second sub-graph. The first node may have a first node data structure comprising information associated with the first node, and the second node may have a second node data structure comprising information associated with the second node. A first information item in the first node data structure may not be present in the second node data structure, and a second information item in the second node data structure may not be present in the first node data structure. Combining the first sub-graph and the second sub-graph may then include generating a combined node data structure for the combined node associated with the first property which includes both the first information item and the second information item. A similar process may be applied to edges which exist in both the first sub-graph and the second sub-graph. Information from the same edge in the first sub-graph and the second sub-graph may be combined into a combined edge data structure associated with the same edge, including information from the edge data structure for the edge in the first sub-graph and the edge data structure for the edge in the second sub-graph.

Further, sub-graphs may be assigned a priority (e.g., may be ordered in a hierarchy), for example based on a determined usefulness of the sub-graph information when provided as input for a machine learning model, or a determined effect on quality of an embedding generated from the sub-graph information of the sub-graph. Where sub-graphs are assigned a priority, edge information from a higher priority sub-graph may overwrite edge information for a same connection between two nodes from a lower priority sub-graph. Alternatively, an edge weight of an edge in a higher priority sub-graph edge may overwrite an edge weight of an edge in a lower priority sub-graph when applied to the combined edge. In some cases, the edge weight of the combined edge may be determined using a calculation, and an edge weight for the combined edge from a higher priority sub-graph may be given a greater impact on the calculation result than an edge weight for the combined edge from a lower priority sub-graph. When the sub-graphs have been combined, the routine 300 moves to block 314.

At block 314, the graph network generation system 130 provides graph network information to the embedding generation module 125 of the embedding generation system 120 to generate embeddings. The embedding generation module 125 may generate embeddings from a combined graph network generated from combining two or more sub-graph networks. In some embodiments, the embedding generation module 125 may generated embeddings for the sub-graphs and the combined graph. The embedding generation module 125 may, for example, use the node2vec algorithm to generate the embeddings for the nodes of a graph network. In some embodiments, the embedding generation module 125 may comprise one or more machine learning models configured to generate embedding information from a graph network. When embeddings have been generated, the routine 300 moves to block 316.

At block 316, the embedding generation system 120 outputs the embeddings generated by the embedding generation module 125. For example, the embedding generation system 120 may output the embeddings to the model application system 150 for use by a model stored in the model store 155, such as a housing model (e.g., a rental model, an affordable housing model, an automated valuation model, etc.). Alternatively, the embeddings may be output to a storage location for later use. When the embedding generation system 120 has output the embeddings, the routine 300 moves to block 318 and ends.

### Example Property Graph Visualizations

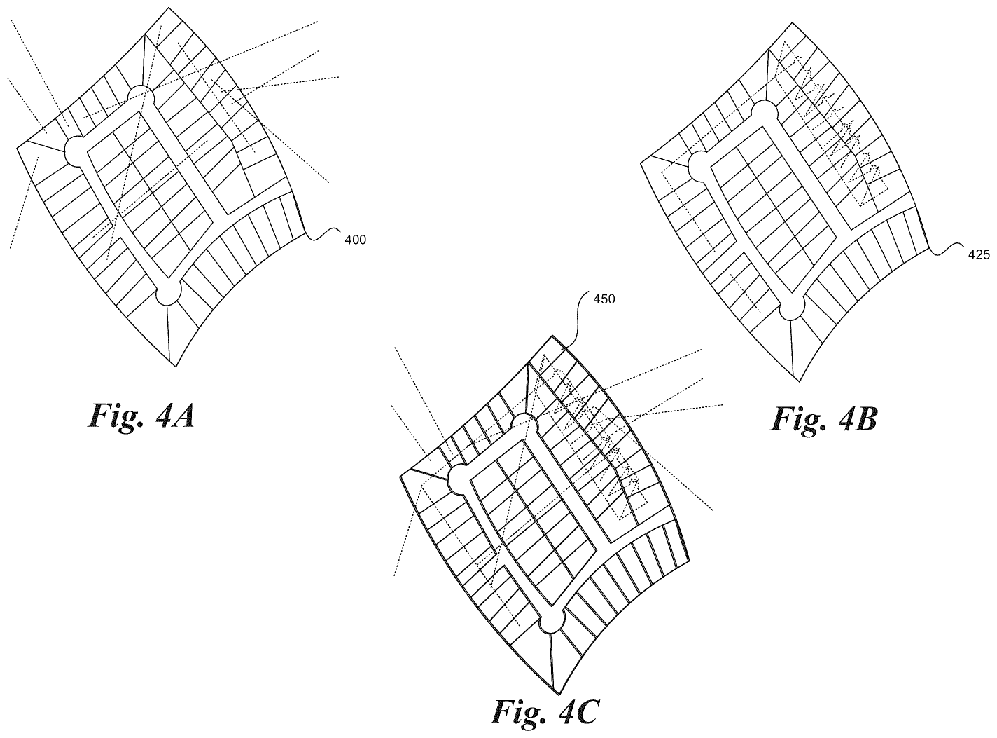

FIG. 4A illustrates an example visualization 400 of a graph network generated based on appraisal comparison information.

FIG. 4B illustrates an example visualization 425 of a graph network generated based on adjacency property information.

FIG. 4C illustrates an example visualization 450 of a combined graph network generated from multiple types of information associated with appraisals and properties.

### Execution Environment

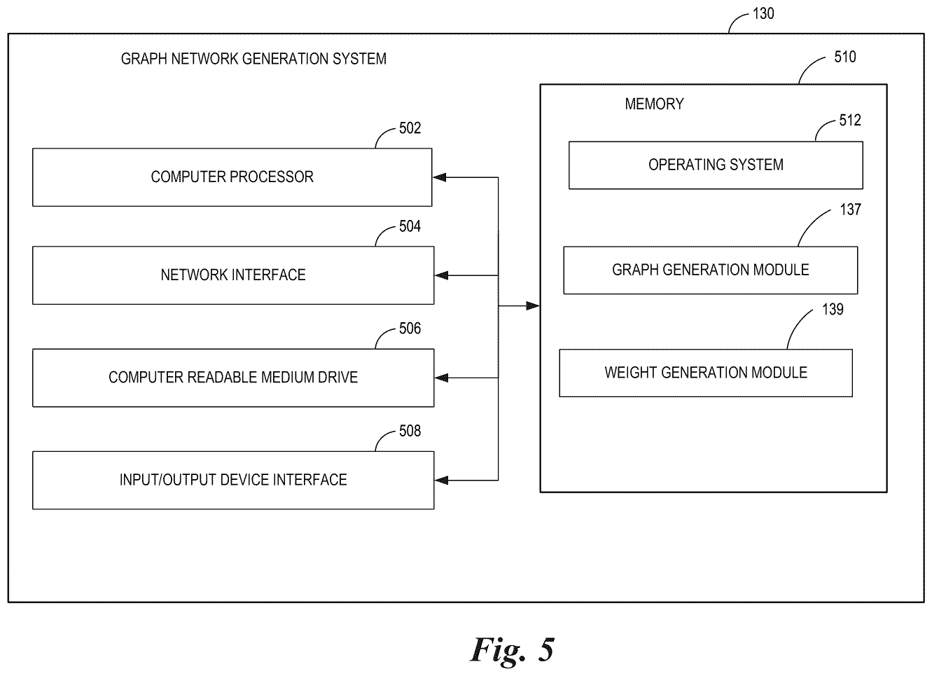

FIG. 5 illustrates various components of an example graph network generation system 130 configured to implement various functionality described herein.

In some embodiments, the graph network generation system 130 may be implemented using any of a variety of computing devices, such as server computing devices, desktop computing devices, personal computing devices, mobile computing devices, mainframe computing devices, midrange computing devices, host computing devices, or some combination thereof.

In some embodiments, the features and services provided by the graph network generation system 130 may be implemented as web services consumable via one or more communication networks. In further embodiments, the graph network generation system 130 is provided by one or more virtual machines implemented in a hosted computing environment. The hosted computing environment may include one or more rapidly provisioned and released computing resources, such as computing devices, networking devices, and/or storage devices. A hosted computing environment may also be referred to as a “cloud” computing environment

In some embodiments, as shown, a graph network generation system 130 may include: one or more computer processors 502, such as physical central processing units (“CPUs”); one or more network interfaces 504, such as a network interface cards (“NICs”); one or more computer readable medium drives 506, such as a high density disk (“HDDs”), solid state drives (“SSDs”), flash drives, and/or other persistent non-transitory computer readable media; one or more input/output device interfaces 508; and one or more computer-readable memories 510, such as random access memory (“RAM”) and/or other volatile non-transitory computer readable media.

The computer-readable memory 510 may include computer program instructions that one or more computer processors 502 execute and/or data that the one or more computer processors 502 use in order to implement one or more embodiments. For example, the computer-readable memory 510 can store an operating system 512 to provide general administration of graph network generation system 130. As another example, the computer readable memory 510 can store graph generation module 137 for processing generating nodes and edge connections of a graph network. As another example, the computer-readable memory 510 can store a weight generation module 139 configured to determine weights of edges of the graph network.

### Terminology

All of the methods and tasks described herein may be performed and fully automated by a computer system. The computer system may, in some cases, include multiple distinct computers or computing devices (e.g., physical servers, workstations, storage arrays, cloud computing resources, etc.) that communicate and interoperate over a network to perform the described functions. Each such computing device typically includes a processor (or multiple processors) that executes program instructions or modules stored in a memory or other non-transitory computer-readable storage medium or device (e.g., solid state storage devices, disk drives, etc.). The various functions disclosed herein may be embodied in such program instructions, or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid-state memory chips or magnetic disks, into a different state. In some embodiments, the computer system may be a cloud-based computing system whose processing resources are shared by multiple distinct business entities or other users.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware, or combinations of electronic hardware and computer software. To clearly illustrate this interchangeability, various illustrative components, blocks, modules, and steps have been described above generally in terms of their functionality. Whether such functionality is implemented as hardware, or as software that runs on hardware, depends upon the particular application and design conditions imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

What is claimed is:

1. A system comprising:
a computer-readable memory that store computer-executable instructions; and
one or more processors in communication with the memory, wherein the computer-executable instructions, when executed by the one or more processors, causes the one or more processors to at least:
receive a first information item;
generate a first graph network based on the first information item, the first graph network comprising a first plurality of nodes, wherein each node of the first plurality of nodes is associated with a property, the first graph network further comprising a first plurality of edges, wherein each edge of the first plurality of edges couples two nodes of the first graph network, and wherein each edge of the first plurality of edges represents a connection between the properties represented by the first plurality of nodes;
receive a second information item;
generate a second graph network based on the second information item, wherein the second graph network comprises a second plurality of edges and a second plurality of nodes;
determine a first node of the first graph network represents a property, wherein the first node is associated with a first node data object;
determine a second node of the second graph network represents the property, wherein the second node is associated with a second node data object;
combine the first node data object with the second node data object to generate a combined node data object, wherein the combined node data object comprises a portion of a combined graph network formed from a combination of the first graph network and the second graph network; and
output the combined graph network.

2. The system of claim 1, wherein the first information item is one of: an appraisal value, geometric property information, address information, socioeconomic information, or census data.

3. The system of claim 2, wherein the second information item is one of: an appraisal value, geometric property information, address information, socioeconomic information, or census data; and
wherein the second information item is different from the first information item.

4. The system of claim 1, wherein the computer-executable instructions, when executed, further cause the one or more processors to:
generate a first plurality of weight values, wherein each weight value of the first plurality of weight values is associated with an edge of the first plurality of edges, and wherein each weight value indicates a strength of coupling between two nodes coupled by the edge associated with the weight value; and
generate a second plurality of weight values, wherein each weight value of the second plurality of weight values is associated with an edge of the second plurality of edges.

5. The system of claim 4, wherein the computer-executable instructions, when executed, further cause the one or more processors to:
determine a first edge of the first plurality of edges couples a first node to a second node, wherein the first edge is associated with a first weight;
determine a second edge of the second plurality of edges couples the first node to the second node, wherein the second edge is associated with a second weight;
receive a hierarchy of graph network data types;
identify a first graph network data type of the first graph network;
identify a second graph network data type of the second graph network;
determine the first graph network data type represents a graph network data type above the second graph network data type in the hierarchy;
combine the first edge with the second edge to generate a combined edge, wherein the combined edge couples the first node and the second node; and
in response to determining the first graph network data type represents the graph network data type at a level indicating a higher priority than the second graph network data type in the hierarchy associate the first weight with the combined edge.

6. The system of claim 5, wherein the first graph network data type is an appraisal value, and wherein the second graph network data type is different from the first graph network data type.

7. The system of claim 4, wherein the computer-executable instructions, when executed, further cause the one or more processors to:
determine a first edge of the first plurality of edges couples a first node to a second node, wherein the first edge is associated with a first weight;
determine a second edge of the second plurality of edges couples the first node to the second node, wherein the second edge is associated with a second weight;
combine the first edge with the second edge to generate a combined edge, wherein the combined edge couples the first node to the second node;
generate an average weight value of the first weight and the second weight; and
associate the average value with the combined edge.

8. A method comprising:
receiving a first information item;
generating a first graph network based on the first information item, the first graph network comprising a first plurality of nodes, wherein each node of the first plurality of nodes is associated with a property, the first graph network further comprising a first plurality of edges, wherein each edge of the first plurality of edges couples two nodes of the first graph network, and wherein each edge of the first plurality of edges represents a connection between the properties represented by the first plurality of nodes;
receiving a second information item;
generating a second graph network based on the second information item, wherein the second graph network comprises a second plurality of edges and a second plurality of nodes;
combining the first graph network and the second graph network to generate a combined graph network, wherein combining the first graph network and the second graph network further comprises:
determining a first node of the first graph network represents a property, wherein the first node is associated with a first node data object;
determining a second node of the second graph network represents the property, wherein the second node is associated with a second node data object; and
combining the first node data object with the second node data object to generate a combined node data object; and
outputting the combined graph network.

9. The method of claim 8, wherein combining the first graph network and the second graph network to generate the combined graph network further comprises:
determining a first edge of the first plurality of edges couples a first node to a second node, wherein the first edge is associated with a first edge data object;
determining a second edge of the second plurality of edges couples the first node to the second node, wherein the second edge is associated with a second edge data object; and
combining the first node edge object with the second edge data object to generate a combined edge data object.

10. The method of claim 8, wherein each edge of the first plurality of edges is associated with an edge data object of a first plurality of edge data objects, wherein each edge of the second plurality of edges is associated with an edge data object of a second plurality of data objects, and wherein the method further comprises:
generating a first plurality of weight values, wherein each weight value of the first plurality of weight values is associated with an edge of the first plurality of edges, wherein each weight value indicates a strength of coupling between two nodes coupled by an edge associated with the weight value, and wherein each weight value of the first plurality of weight values is stored in an edge data object of the first plurality of edge data objects; and
generating a second plurality of weight values, wherein each weight value of the second plurality of weight values is associated with an edge of the second plurality of edges, and wherein each weight value of the second plurality of weight values is stored in an edge data object of the second plurality of edge data objects.

11. The method of claim 10, further comprising:
determining a weight value of the first plurality of weight values fails to reach a threshold value; and
removing an edge of the plurality of edges associated with the weight value from the plurality of edges.

12. The method of claim 10, further comprising:
determining a weight value of the first plurality of weight values exceeds a threshold value; and
based on determining the weight value exceeds the threshold value, storing the weight value.

13. The method of claim 8, further comprising generating a graph network embedding for the combined graph network, using a machine learning model configured to generate an embedding based on receiving a graph network as input.

14. The method of claim 13, further comprising:
providing the graph network embedding as input to a housing model configured to accept an embedding as input and generate a housing information item; and
receiving the housing information item.

15. The method of claim 8, wherein the first information item is of a first information type, wherein the second information item is of a second information type, and wherein the first information type is different from the second information type.

16. A non-transitory, computer-readable medium encoded with computer-executable instructions executable by a processor of a computing device, wherein the computer-executable instructions, when executed by the processor, cause the computing device to:
receive a first information item;
generate a first graph network based on the first information item, the first graph network comprising a first plurality of nodes, wherein each node of the first plurality of nodes is associated with a property, the first graph network further comprising a first plurality of edges, wherein each edge of the first plurality of edges couples two nodes of the first graph network, and wherein each edge of the first plurality of edges represents a connection between the properties represented by the first plurality of nodes;
receive a second information item;
generate a second graph network based on the second information item, wherein the second graph network comprises a second plurality of edges and a second plurality of nodes;
determine a first node of the first graph network represents a property, wherein the first node is associated with a first node data object;
determine a second node of the second graph network represents the property, wherein the second node is associated with a second node data object;
combine the first node data object with the second node data object to generate a combined node data object, wherein the combined node data object is associated with a combined node, and wherein the combined node represents the property, and wherein the combined node data object comprises a portion of a combined graph network formed from a combination of the first graph network and the second graph network; and
output the combined graph network.

17. The non-transitory, computer-readable medium of claim 16, wherein the computer-executable instructions, when executed, farther cause the computing device to:
determine the combined node data object comprises a data element that fails to exceed a threshold value; and
in response to determining the combined node data object comprises a data element that fails to exceed the threshold value, remove the combined node from the combined graph network.

18. The non-transitory, computer-readable medium of claim 16, wherein the first information item is of a first information type, wherein the second information item is of a second information type, and wherein the first information type is different from the second information type.

19. The non-transitory, computer-readable medium of claim 16, wherein the computer-executable instructions, when executed, further cause the computing device to:
determine a property of a plurality of properties associated with each node of the first plurality of nodes;
determine the property of the plurality of properties associated with each node of the second plurality of nodes; and
combine a first node data object of the first plurality of node data objects associated with each property and a second node data object of the second plurality of node data objects associated with each property to generate a combined plurality of node data objects,
wherein the combined graph network further comprises the combined plurality of node data objects.

20. The non-transitory, computer-readable medium of claim 16, wherein the computer-executable instructions, when executed, further cause the computing device to:
determine a third node of the first plurality of nodes is associated with a second property; and
determine the second property is not associated with any node of the second plurality of nodes,
wherein the combined graph network further comprises a third node data object associated with the third node.
